(19) United States
(12) Patent Application Publication
(10) Pub. No.: US 2025/0363732 A1
(43) Pub. Date: Nov. 27, 2025

(54) VIRTUAL PET FEATURES IN INTERACTION FUNCTIONS

(71) Applicant: Snap Inc., Santa Monica, CA (US)

(72) Inventor: Nathan Kenneth Boyd, Los Angeles, CA (US)

(21) Appl. No.: 18/674,277

(22) Filed: May 24, 2024

(51) Int. Cl. G06T 17/00; G06T 13/40; H04L 51/046

(52) U.S. Cl. CPC G06T 17/00; G06T 13/40; H04L 51/046

(57) ABSTRACT

Described is a system for generating a virtual pet by determining participation in an interaction function by a first user of an interaction system with a second user of the interaction system; accessing profile data of the first user; determining, based on the profile data, whether the first user has a virtual pet for use in the interaction function; initiating display of the virtual pet with an avatar of the first user in an uncollapsed state in the interaction function to a computing device of the second user; determining that the first user is typing a message in the interaction function; and initiating display of the virtual pet with the avatar of the first user in a first state in the interaction function, the first state including a visual indicator indicating that the first user is typing the message.

### TECHNICAL FIELD

The present disclosure relates generally to virtual pet features and, in particular, to virtual pet features in interaction functions, such as messaging applications.

### BACKGROUND

The popularity of electronic messaging, particularly instant messaging, continues to grow. Users increasingly share media content items such as electronic images and videos with each other. Users are using their mobile devices to communicate with each other using interaction applications. Users also utilize mobile devices to communicate with each other using various systems that include messaging functionality (also referred to as chat functionality) suitable for sharing such messages.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates a method in accordance with one embodiment.

FIG. 5 illustrates a user interface 500 where only the user is displayed, according to some examples.

FIG. 6 illustrates a user interface where the user and the virtual pet is displayed, according to some examples.

FIG. 7 illustrates a first version of the virtual pet and user where the first version is between the uncollapsed and collapsed version, according to some examples.

FIG. 8 illustrates a visual indicator indicating that a user is currently typing in the interaction function, according to some examples.

FIG. 9 illustrates virtual pets in chat using artificial intelligence (AI) models, according to some examples.

FIG. 10 illustrates a user's three dimensional avatar, according to some examples.

FIG. 11 illustrates guidelines to add a virtual pet adjacent to the user's avatar, according to some examples.

FIG. 12 illustrates a final view of the user's avatar with the virtual pet, according to some examples.

FIG. 13 is a diagrammatic representation of a message, according to some examples.

FIG. 14 illustrates a system including a head-wearable apparatus with a selector input device, according to some examples.

FIG. 15 is a diagrammatic representation of a machine in the form of a computer system within which a set of instructions may be executed to cause the machine to perform any one or more of the methodologies discussed herein, according to some examples.

FIG. 16 is a block diagram showing a software architecture within which examples may be implemented.

FIG. 17 illustrates a machine-learning pipeline, according to some examples.

FIG. 18 illustrates training and use of a machine-learning program, according to some examples.

### DETAILED DESCRIPTION

Traditional systems with avatars in messaging applications typically involve static or limited dynamic representations of users' virtual identities. Traditional systems often use static avatars, which are pre-designed images or animations that represent users. These avatars lack real-time customization and dynamic interactions, thereby limiting their ability to reflect users' current activities or emotions.

Users are usually provided with a limited set of customization options for their avatars, such as choosing from preset hairstyles, clothing, and facial features. This limited customization can lead to generic or repetitive avatars that do not fully capture users' individuality.

Avatars in traditional systems typically have limited interactivity, with basic actions like changing poses or expressions. They often lack the ability to respond contextually to user actions or engage in meaningful interactions with other avatars.

Traditional avatar systems lack robust context awareness, meaning they cannot adapt their appearance or behavior based on real-time user activities, messaging context, or environmental factors.

Rendering complex three-dimensional (3D) avatars or dynamic animations in real time can strain system resources and lead to performance issues, especially in low-powered devices or high-traffic scenarios. Moreover, traditional systems struggle to handle diverse avatar customizations and interactions seamlessly, resulting in limited scalability and user engagement. Without advanced AI and machine learning capabilities, traditional systems find it challenging to adapt avatars based on contextual cues, such as user behavior, sentiment analysis of conversations, or external factors like location and activity.

Avatars in traditional systems are often confined to basic communication channels, such as text chat or predefined animations. This restricts the potential for immersive and expressive communication experiences. Overall, traditional avatar systems face technical limitations in terms of customization, interactivity, context awareness, and adaptability, which can impact user engagement and the overall user experience in messaging apps.

Example embodiments of the interaction system described herein mitigate or eliminate the pitfalls of traditional systems. The interaction system significantly improves on the pitfalls of traditional avatar systems by introducing advanced features and technologies that enhance customization, interactivity, context awareness, and adaptability.

The interaction system allows for dynamic and customizable avatars, enabling users to personalize their virtual identities with a wide range of options for hairstyles, clothing, accessories, facial features, and more. This extensive customization ensures that avatars reflect users' individuality accurately.

Avatars in the interaction system are highly interactive and capable of real-time responses and dynamic animations based on user actions, messaging context, and environmental factors. This level of interactivity enhances user engagement and immersion within the messaging application.

Leveraging advanced AI and machine learning algorithms, the interaction system excels in context awareness to adapt avatars' appearance, behavior, and interactions based on real-time user activities, sentiment analysis of conversations, historical user data, location, and other contextual cues.

The interaction system integrates cutting-edge AI technologies, such as Large Language Models (LLMs), Generative AI (GenAI), Stable Diffusion Models, and Personalized AI (MyAI), to power various functionalities. This includes generating realistic images and videos for avatar actions, enabling avatars to engage in natural language conversations, recommending pet types based on user preferences, and matching pet behaviors with user behavior.

One of the unique aspects of the interaction system is also the addition of pet features alongside avatars, enhancing user interactions with virtual pets that can dynamically respond to user activities, sentiments, and environmental cues. Furthermore, the interaction system extends pet features to discussions in AR/VR environments, providing a seamless and immersive experience across platforms.

By addressing these technical pitfalls and incorporating advanced features and technologies, our interaction system revolutionizes avatar experiences in messaging apps, offering users unparalleled customization, interactivity, context awareness, and adaptability for a more engaging and personalized communication experience.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in a virtual pet generation and modification process. Computing resources used by one or more machines, databases, or networks may thus be more efficiently utilized or even reduced.

### Networked Computing Environment

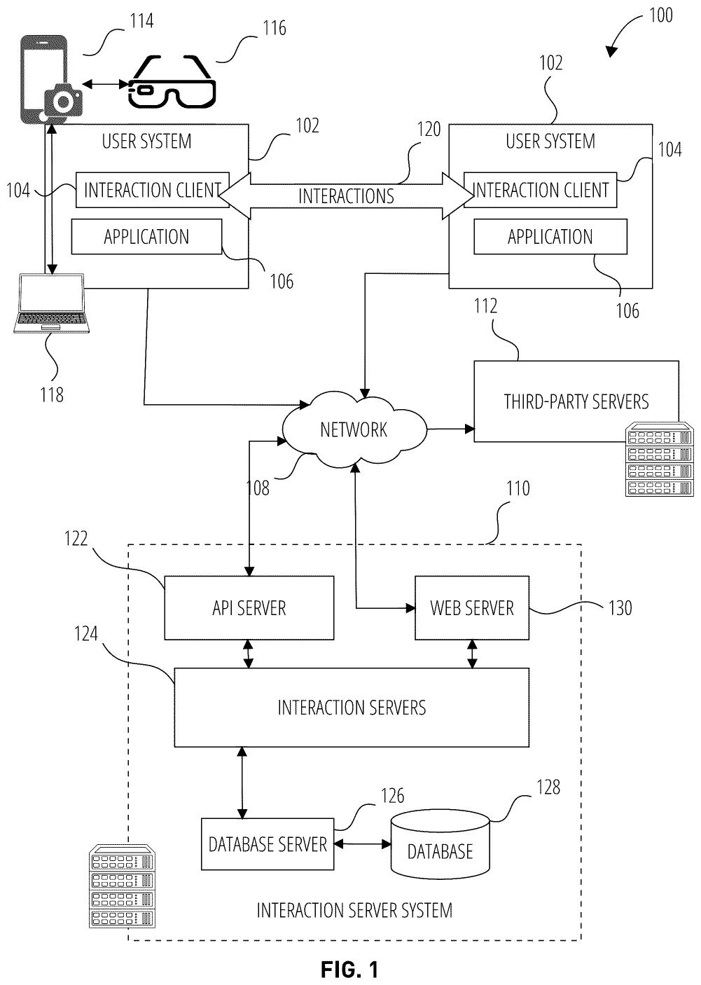

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

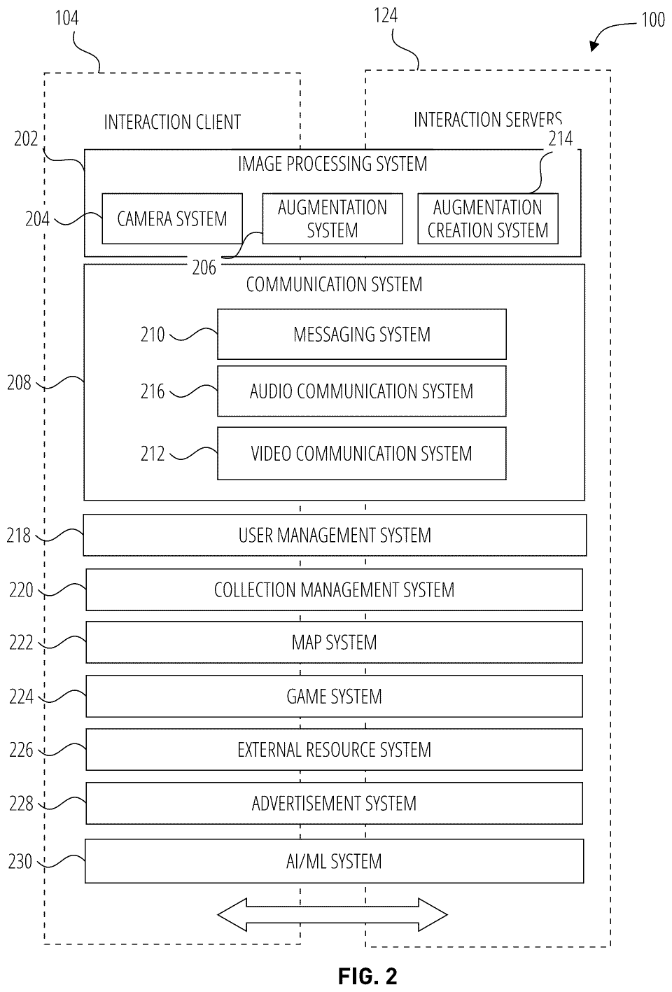

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 1402 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

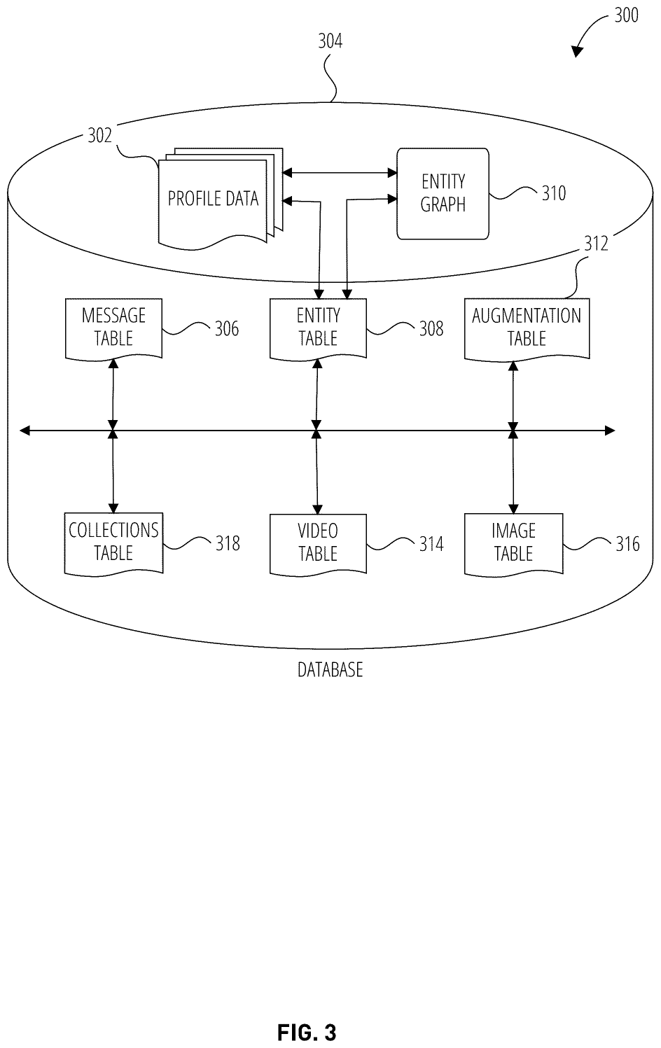

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, the system operating within the interaction client 104 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

### Virtual Pet Features in Interaction Functions

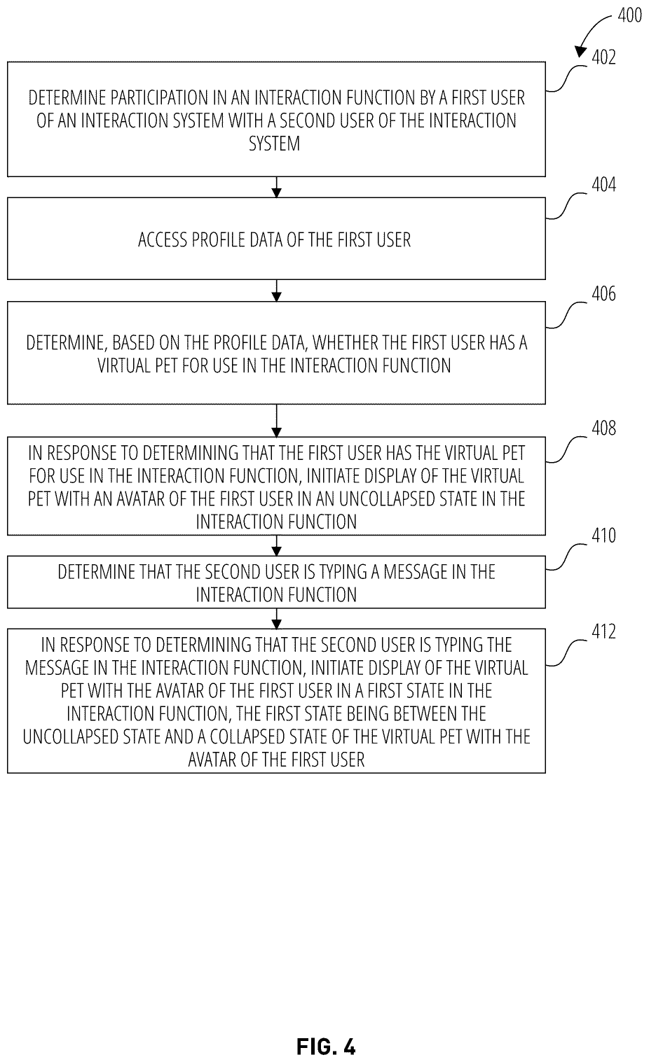

FIG. 4 illustrates an example method 400 for performing virtual pet features in interaction functions. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At block 402, the interaction system determines participation in an interaction function by a first user of an interaction system with a second user of the interaction system. For the sake of brevity, embodiments are described as one type of interaction function, such as messages sent between users. However, it is appreciated that the features described herein apply to other interaction functions.

In some examples, interaction functions include user interaction with a camera feed displayed on the user system 102, such as selecting a real-world object on a camera feed or selecting a digital item or overlay shown on the camera feed. In some examples, interaction functions also include a chat window where messages, stickers, emojis, and other media content items are shared between users via user systems 102.

Interaction functions further include sending photos or videos to friends, either individually or in groups, which are edited with text, stickers, filters, and drawings before being sent. Interaction functions include capturing a video or audio, inputting text, or other communications that disappear after certain conditions are met, such as being viewed once or setting a time limit, creating a more ephemeral and casual sharing experience.

In some examples, interaction functions include generating or viewing a collection of videos, messages, stickers, or other media content items that are visible to friends for a certain period of hours (e.g., 24 hours). Interaction functions include displaying media content items from other users, such as publishers, creators, and influencers, where users explore and subscribe to different channels to receive updates on their favorite content. Interaction functions include map and location functions, such as users sharing their location with friends and viewing their friends' locations on a map, or exploring a map with points of interest by other users categorized by location and events.

In some examples, interaction functions include generating or applying various filters and content augmentations to enhance images, videos, or other media content items to share with others, such as by adjusting the color or appearance or adding interactive elements such as animations and facial transformations in real-time. Interaction functions include saving favorite media content items with other users in a private archive, where users access these saved media content items later and can edit them or share them with friends.

Interaction functions include personalizing or applying avatars, which are used as a profile picture to be viewed by others and in stickers, chat, and image/video decorations. Interaction functions include playing multiplayer games that users play with their friends directly within the user interface of the system to share messages and media content items.

Interaction functions include capturing data by an Augmented Reality (AR) device. In some examples, the interaction system 100 captures motion and position data, such as data from accelerometers, gyroscopes, and magnetometers to track user movement or orientation. In some examples, the interaction system 100 captures eye-tracking data that monitors the user's eye movements and focus, gaze-based interactions, objects the user is focused (or not focused) on, or user attention patterns.

In some examples, the interaction system 100 captures facial expressions. In some examples, the interaction system 100 captures biometric data, such as heart rate, body temperature, or skin conductivity. In some examples, the interaction system 100 captures data related to user interactions within the virtual or augmented environment, such as objects or buttons users interact with, the time spent in specific areas, or the choices users make. In some examples, the interaction system 100 captures voice data, voice recognition, voice commands, and/or the like. In some examples, the interaction system 100 captures location data, such as a user's GPS location. In some examples, the interaction system 100 captures usage data related to how and when the devices are used, session duration, frequency of use, and user engagement with specific content or applications.

In some examples, other users, such as the second user, that are associated with the user (such as within an interaction function of the interactive system) include followers or friends, where users can follow or be followed by others, or form some form of relationship such that other users can see certain information, such as each other's posts on their feeds. In some examples, the other users can include “close” or “best” friends that can create a relationship to share additional information not available to others, such as private posts, targeted sharing of content, and/or the like. In some examples, other users are users mentioned or tagged in the user's posts, comments, chat messages, or other communication that draws the attention of the tagged user and/or can initiate conversations or discussions. In some examples, other users are users that are involved in a message chat with the user, such as a private messaging feature that allows users to send messages directly to one another or group chats among many users. In some examples, other users are users that joined a group based on shared interests or common goals. Within these groups, users can interact and form relationships based on the group's focus and/or share information among group members. In some examples, other users are users who express support for users, such as through likes, comments, or shares, or vice versa. In some examples, other users are influencers or brand ambassadors that have established large followings and are seen as authorities or trendsetters in their niches. In some examples, other users are collaborators working together on projects or creating content together.

At block 404, the interaction system accesses profile data of the first user. Profile data of users includes personal information, such as a name, email address, phone number, date of birth, gender, education, occupation, interests, and/or the like. Profile data of users includes profile pictures, cover photos, biographies, and any other customizations made by the user to their online profiles. Profile data of users includes connections and relationships with other users, such as a user's friends, followers, and connections, as well as the groups and pages they follow or like. Profile data of users includes content users share, such as text, photos, videos, and links, and direct messages, comments, and any other interactions users have within the platform. Profile data of users includes location data, such as the user's city or precise GPS coordinates, such as when using location-based features or when sharing content with location tags. Profile data of users includes how users interact with the platform's services, such as the content they view, like, share, or engage with, as well as the features they use and the duration of their sessions. Profile data of users includes data about the devices used to access their services, including device model, operating system, browser type, Internet Protocol (IP) address, and unique identifiers like device IDs or cookies.

At block 406, the interaction system determines, based on the profile data, whether the first user has a virtual pet for use in the interaction function. Within the interaction system (such as in the user's profile settings or in the interaction system), an option is displayed to enable or disable virtual pets for use in the interaction function. This setting allows users to control whether they want the pet features to be active during their conversations. When a user enters a conversation or initiates an interaction within the messaging application, the interaction system checks the user's profile data to verify if they have enabled virtual pets.

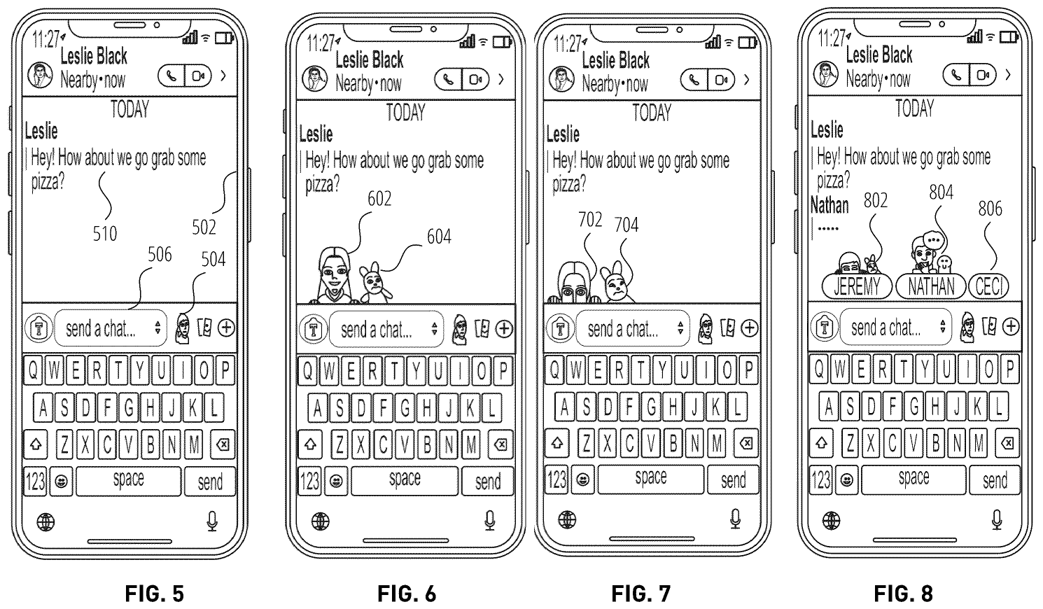

If the user has not enabled virtual pets, the interaction system does not display any pet-related features, and only the user's avatar 504 or emoji is shown. FIG. 5 illustrates a user interface 502 where only the user is displayed, according to some examples. The interaction system is displaying a messaging application where users can submit messages in the message box 506, and messages, such as message 510, appear in the message application. In this example, the user has not enabled virtual pets and as such, only the user is displayed in the messaging application.

In some cases, when the virtual pets are not enabled, the user interface of the user can show a user interface element causing the system to enable the user to apply the virtual pet in the interaction function or enable the user to create a pet if one is not already created.

At block 408, the interaction system, in response to determining that the first user has the virtual pet for use in the interaction function, initiates display of the virtual pet with an avatar of the first user in an uncollapsed state in the interaction function. The virtual pet and the avatar of the first user can be displayed on a computing device of the second user.

If the user has enabled virtual pets, the interaction system proceeds to display the user's avatar or emoji along with their virtual pet next to it. FIG. 6 illustrates a user interface where the user and the virtual pet are displayed, according to some examples. The interaction system is displaying a messaging application. In this example, the user has enabled virtual pets and as such, the user 602 and the virtual pet 604 are displayed in the messaging application.

In some cases, the virtual pets are enabled upon a subscription of the platform. Upon the user subscribing to the subscription of the platform, such as by paying a monthly fee, the user has access to the virtual pets. Upon the subscription ending, the platform can disable use of the virtual pets. Responsive to the user resubscribing back to the subscription, such as within 30 days, the system can automatically enable virtual pet use in interaction functions.

Upon entering the chat, the uncollapsed version of the user and pet bodies is displayed for a certain period of time, as specified in the system settings. The user 602 and the virtual pet 604 are displayed in the uncollapsed version in FIG. 6. The uncollapsed version in this context refers to a display mode where the user's shoulders are shown and more of the body for the virtual pet is shown next to the user's avatar or emoji during conversations. This version provides a fuller view of the user and pet bodies, enhancing the interactive and visual experience for users engaging in conversations by allowing a more detailed representation of the virtual pet's appearance and actions.

At block 410, the interaction system determines that the second user is typing a message in the interaction function. The system continuously monitors the chat or messaging interface in real-time to detect any user activity, such as typing. In other cases, the system identifies when an input, such as a user typing, is detected by using algorithms to detect keystrokes or text input events generated by the second user (e.g., using browser-based events, API callbacks, or direct monitoring of keyboard inputs).

The system analyzes the timing and frequency of keystrokes to distinguish between deliberate typing and pauses. This helps ensure that the indication of typing is accurate and reflects actual user activity rather than intermittent or background processes. Such timing can be used to change or modify features corresponding to the virtual pets, such as different display modes or actions as further described herein.

When a user enters the chatroom, the system initially displays the uncollapsed version of the user and virtual pet, such as shown in FIG. 6. In this uncollapsed version, more of the user's shoulders are shown and more of the virtual pet's body is shown next to the user's avatar or emoji, thereby providing a fuller view and enhancing the visual experience.

After a certain time period has passed, the system transitions to display a second version of the virtual pet. This second version is designed to be somewhere between the uncollapsed version and a collapsed version (where neither the virtual pet nor the user is shown). In this intermediate state, the virtual pet may be partially visible, showing specific features or a reduced portion of its body, while still maintaining a compact and streamlined display.

FIG. 7 illustrates a second version of the virtual pet and user where the second version is between the uncollapsed and collapsed version, according to some examples. As shown in the second version (or state), the shoulders of the user 702 are not shown and less of the body of the virtual pet 704 is shown. Only a portion of the user's head is shown but the full head of the virtual pet is shown.

The purpose of transitioning from the uncollapsed version to the second version of the virtual pet is to optimize screen space and visual clarity over time. Initially showing more details in the uncollapsed version allows users to have a richer visual experience when they first enter the chatroom. As time passes and the conversation continues, transitioning to the second version helps prevent visual clutter and maintains a balanced presentation of the user, avatar, and virtual pet elements within the messaging interface.

This approach ensures that users can enjoy a visually engaging experience with the virtual pet without compromising readability or usability, with the display adapting based on user activity and the duration of their presence in the chatroom.

At block 412, the interaction system, in response to determining that the second user is typing the message in the interaction function, initiates display of the virtual pet with the avatar of the second user in a first state in the interaction function, the first state being between the uncollapsed state and a collapsed state of the virtual pet with the avatar of the second user.

The uncollapsed state of the virtual pet refers to a display mode where more details of the pet are shown, requiring a larger pixel size to accommodate these details. For example, the uncollapsed state might be displayed at 56 pixels in size. This larger pixel count allows for a more detailed and visually rich representation of the pet's features, such as fur texture, facial expressions, or accessories.

On the other hand, the first state of the virtual pet, which is between the uncollapsed and collapsed states, may be displayed at a smaller size, such as 38 pixels. This reduced pixel count can be selected by the system to balance between visibility and conserving screen space. In this state, the virtual pet retains some level of detail but in a more compact form, ensuring that the first state does not take up excessive room in the chat interface while still being recognizable and engaging.

In some cases, the decision to vary the pixel sizes between the uncollapsed and first state versions of the virtual pet is dynamic. The system can provide a comprehensive view of the pet initially (uncollapsed) to enhance the visual experience, and then transition to a more streamlined representation (first state) as the conversation progresses, optimizing the use of screen real estate without sacrificing the pet's presence and impact in the chatroom. The system can consider the screen size and resolution of the device where the messaging application is being accessed. Larger screens with higher resolutions may allow for larger pixel sizes without sacrificing clarity, while smaller screens may require more compact representations.

Users may have preferences regarding the size of virtual pets or avatars displayed in the chat interface. The system can provide options for users to customize the pixel size based on their preferences. In some cases, the system can adhere to interface design guidelines that recommend specific pixel sizes for elements within the chat interface, which ensures consistency and readability across different devices and platforms.

Utilizing dynamic scaling techniques, the system can adjust the pixel size based on available screen space. For example, when the chat interface is resized or when other elements are displayed, the system can dynamically scale the virtual pet's size to fit the available space effectively. Depending on the context of the conversation or user activity, the system may vary the pixel size. For instance, during certain interactive moments or when specific features are activated, the virtual pet's size could change to emphasize its role or engagement level.

Considering accessibility, the system may allow users to adjust pixel sizes to accommodate visual preferences or accessibility requirements, such as larger sizes for users with visual impairments. Different device types (e.g., smartphones, tablets, desktops) may have varying optimal pixel sizes for virtual pets or avatars. The system can adapt based on the device type to ensure an optimal viewing experience.

FIG. 8 illustrates a visual indicator indicating that a user is currently typing in the interaction function, according to some examples. Once the system detects consistent typing activity, the system triggers user interface indicators to notify other participants in the conversation. These indicators can include a visual indicator next to the second user's avatar or name, such as an animated ellipsis or visual cloud ( . . . ) or a “typing” label. Further, such visual indicators can include temporary changes in the appearance of the chat interface, such as a text input field expanding or displaying a typing animation.

The system may use a communication protocol (e.g., WebSocket, HTTP long polling) to transmit real-time updates about typing status to all participants in the conversation. This ensures that the typing indicator is synchronized across multiple devices and platforms.

To maintain a responsive and seamless user experience, the system optimizes the detection and display of typing indicators. This includes minimizing latency in updating the indicator, handling concurrent typing events from multiple users, and ensuring compatibility with different devices and network conditions.

FIG. 8 illustrates a visual indicator indicating that a user is currently typing in the interaction function, according to some examples. The system recognizes the trigger event, which in this case is the second user typing a message. This trigger event serves as a cue for the system to activate the display of the virtual pet alongside the first user's avatar.

When the user is typing, an uncollapsed version with an indicator (e.g., a bubble with . . . ) is shown above the user's head 804, indicating the typing activity. Other users/pets remain in a collapsed version to optimize screen space and readability. In some cases, the bubble or other visual indicator is applied to the user and the pet can be modified, such as looking up to the user with the visual indicator that the user is typing.

In some cases, in a group chat, with multiple users, the user interface expands the section displaying the virtual pets and the avatars of the users. For example, the first state of Jeremy's virtual pet and avatar 802 is displayed on the left, Nathan's virtual pet and avatar 802 is displayed in the middle, and Ceci 806, who does not have the virtual pet or avatar enabled, is displayed on the right.

The system transitions the virtual pet from a previous state (such as a collapsed state, a fully uncollapsed state, or the second state) to the first state. This first state includes a state between the uncollapsed state (where more of the user and pet bodies are shown) and a collapsed state (where a smaller portion of the user and pet bodies are shown).

In the first state, the virtual pet is displayed next to the avatar of the first user in a manner that reflects a partial view of both the user and the pet. This could include showing the upper body or specific features of the pet, depending on the design and configuration of the interaction function.

The system adjusts the user interface to accommodate the display of the virtual pet in the first state. The system can resize elements, position the pet relative to the avatar, and ensure that the display remains visually appealing and coherent within the messaging app's design.

Displaying the virtual pet in the first state serves as interactive feedback for the first user, indicating that the second user is actively engaged in the conversation by typing a message. This visual cue adds a layer of engagement and immersion to the messaging experience, especially when combined with other interactive elements such as typing indicators and animations.

Depending on the system's capabilities and user preferences, the virtual pet in the first state may exhibit dynamic behaviors or animations to further enhance the interactive experience (as further described herein). For example, the pet could be shown looking towards the typing indicator or displaying a subtle animation to indicate anticipation or curiosity.

Although examples described herein include a virtual pet or a virtual dog, it is appreciated that other virtual objects can be included. For example, a virtual assistant can be displayed next to the user's avatar in messaging applicant submits, which can provide helpful information, suggest replies, or perform tasks based on user interactions. A personalized avatar extension, such as a mini version of the user's character from a game or virtual world, can accompany the user's avatar in chats, which can reflect the user's style and preferences. Companies or brands can create digital mascots that appear next to users' avatars, adding a touch of branding or personality to conversations.

Animated emojis or stickers can be used as virtual companions, reacting to the conversation's tone or content with expressive animations. In the context of AI-driven chatbots, an animated avatar representing the chatbot's persona can accompany messages, making the interaction more engaging and human-like. Virtual representations of famous fictional characters, such as superheroes, movie characters, or fantasy creatures, can serve as companions in chats, adding a playful or thematic element to conversations.

Rather than a traditional pet, a virtual pet simulator can feature various creatures or entities that evolve based on user interactions and activities within the messaging app. Users can create and customize their own virtual companions, choosing features, accessories, and behaviors that reflect their personality or mood during conversations. Virtual representations of natural elements like plants, animals, or elements of the environment can accompany users in chats, providing a calming or thematic ambiance. Instead of a static companion, interactive mini-games, media content items, or activities can be integrated into the chat interface, allowing users to engage with virtual elements dynamically during conversations.

The media content items include:
Content augmentations to enhance images, videos, or other media content items to share with others, such as by adjusting the color or appearance or adding interactive elements such as animations and facial transformations, in real-time.
Emojis are small images or icons that represent emotions, reactions, or objects.
Stickers are larger images or animations that can be sent in a chat window.
Images or photographs can be sent to other users to share visual information or document a particular event.
Video clips can be used to share recorded content or document a particular event.
Audio messages can be shared to communicate audible communication.
Graphics Interchange Formats (GIFs) are short animations that can be used to add humor or express emotions.

### Virtual Pets in Chat Using Artificial Intelligence Models

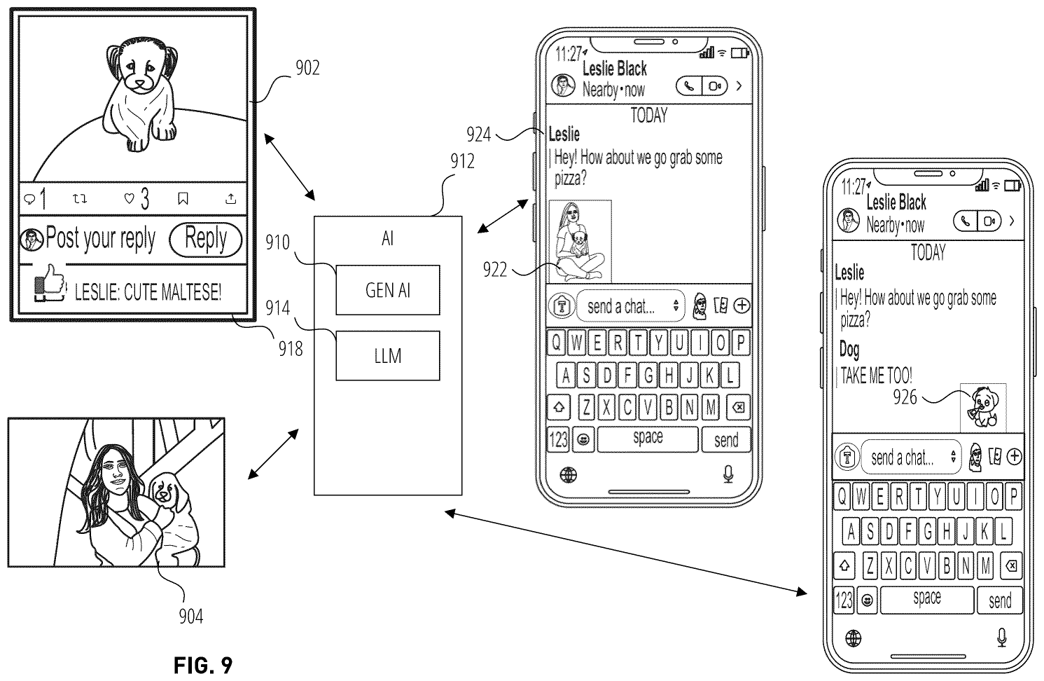

FIG. 9 illustrates virtual pets in chat using AI models, according to some examples. FIG. 9 is described as being performed by certain systems or applying certain processes, such as a particular machine learning model or computer vision model, but the processes described herein can be performed by one or more other or the same machine learning models, computer vision models, or a combination thereof.

The AI module 912 can collect various types of interaction data from the user within the platform. This data can include user-generated content, such as selfies with pets 904, comments, likes, and shares, user preferences, expressed through interactions with different features, posts, or profiles on the platform, or behavioral patterns, such as frequency of interactions, time spent on specific content, and engagement levels. For example, the AI module identifies that the first user liked a post 902 of a Maltese by responding to the post with “cute maltese!” 918.

The AI module processes the collected interaction data using one or more of machine learning algorithms and natural language processing techniques. The AI module analyzes patterns, sentiments, and user preferences embedded within the data to extract meaningful insights, such as via a LLM 914. The LLM can be trained to take as input text corresponding to user interaction data and output a personality characteristic or a pet characteristic for the user.

Based on the analyzed data, the AI module identifies information about the user, such as personality traits based on language use, interaction styles, and content preferences. For example, the AI module may determine that a user is outgoing, adventurous, or empathetic. The AI module can identify pet preferences by analyzing interactions related to pets, such as liking posts about specific dog breeds or sharing content featuring pets, and thus, the AI module can identify the types of pets the user owns or likes.

Using the identified information, the system can generate a virtual pet that reflects the user's personality or pet preferences. For instance, if the AI module determines that a user is fond of energetic and playful dogs, the system applies a generative AI module 910, such as a stable diffusion model, to generate a virtual pet with similar characteristics.

Alternatively, the system can recommend a virtual pet from a predefined set of options that best match the user's profile information captured by the AI module. This recommendation takes into account factors such as pet type, breed, temperament, and appearance.

After generating or recommending the virtual pet, the system allows the user to interact with and customize the pet further. Users can provide feedback, make adjustments, and engage with the virtual pet through various activities and features within the platform.

In some cases, generating the virtual pet comprises applying the pet characteristic to a generative AI model as a prompt to receive an image of a pet. The generative AI module can be trained to generate images based on corresponding inputted prompts. The process begins by applying characteristics of the virtual pet (e.g., breed, color, size, features) as prompts to the generative AI model. These prompts serve as input instructions that guide the model in generating an image of the virtual pet.

The generative AI model can include a type of machine learning model trained to generate images based on specific input prompts. The model utilizes techniques such as deep learning and neural networks to learn patterns and features from training data.

In some cases, the generative AI model, which can include the stable diffusion model, is trained using a dataset of pet images. This dataset provides the model with a diverse range of pet characteristics, appearances, and variations to learn from. The stable diffusion model introduces noise iteratively to update pixel values in a generated image based on neighboring pixels. This iterative process refines the image generation by gradually adjusting pixel values to create realistic and detailed images.

During the image generation process, the stable diffusion model introduces noise, which represents small random variations in pixel values. This noise helps the model explore different possibilities and create diverse variations of the virtual pet image. The model iteratively updates pixel values based on neighboring pixels and the introduced noise. This iterative refinement process contributes to generating high-quality and visually appealing images of the virtual pet.

As the stable diffusion model iteratively refines pixel values based on the input prompts and noise, the model generates an image of the virtual pet. The output image reflects the characteristics and features specified in the prompts, such as the pet's breed, color patterns, facial expressions, and other details.

In some cases, the LLM identifies the context of a conversation between two users, such as discussing eating pizza. The LLM processes the text inputs to identify key elements, such as the mention of pizza, food-related discussions, and potential actions related to eating. When the second user messages, “Hey! How about we go grab some pizza?” 924, the LLM recognizes the intent behind the message, which is to suggest going out to eat pizza.

Based on the recognized context and intent, the system can update the virtual pet's behavior or appearance to reflect the ongoing conversation. For example, the virtual pet can be shown eating a slice of pizza 926 in response to the conversation about pizza. The virtual pet's expression or animation may change to indicate excitement or anticipation related to the suggestion of grabbing pizza. The virtual pet's dialogue or actions can be adjusted to align with the conversation's context, such as expressing interest in joining for pizza or displaying food-related behaviors.

The system's ability to dynamically update the virtual pet based on contextual understanding enhances the interactive and immersive nature of the conversation. It creates a sense of continuity and relevance, as the virtual pet's actions or responses mirror the topics and activities discussed by the users. Users engaging in the conversation with the virtual pet may find it more engaging and relatable when the pet's behavior or appearance reflects the context of the discussion. This personalized and context-aware interaction adds depth and realism to the virtual pet's interactions within the messaging environment.

In some cases, if the conversation topic revolves around walking, such as discussing a walk in the park or exercise routines, the system can animate the virtual pet to walk across the screen. This animation adds dynamism and context to the conversation, aligning the virtual pet's actions with the discussion theme.

In some cases, the system can tailor the virtual pet's behavior based on the user's known preferences or observed behaviors. If the system identifies that the user is active and likes to move around, the system can animate the virtual pet to walk around the screen. This dynamic behavior reflects the user's energetic nature.

If the system has access to videos or interactions where the user's real dog is seen chasing its tail, the system can infer that the user's pet enjoys this behavior. In response, the virtual pet can be animated to playfully chase its own tail on the screen.

The system creates a more immersive and relatable experience by personalizing the virtual pet's actions based on user characteristics or observed behaviors in the same or other interaction functions. The system can enable the users to obtain a deeper connection with the virtual pet when its behaviors mirror their own or their pet's real-life actions.

When the user is not actively using the messaging application or is away from their computing device (such as a phone), the virtual pet can step in to respond on behalf of the user.

In some cases, the system monitors various indicators to detect when the user is inactive or not using the messaging app. This can include checking the time stamp of the last user action, detecting that the messaging app is no longer displayed on the user interface, or recognizing that the app has been closed on the mobile phone.

Once the system determines that the user is away, the system triggers the virtual pet to respond to incoming messages. In the example of FIG. 9, when Leslie sends the message “Hey! How about we go grab pizza?” 924 and the system detects the user's inactivity, the virtual pet can then generate a response on behalf of the user. In response to Leslie's message, the virtual pet could say something playful and interactive like “Take me too!” or illustrate the virtual pet eating pizza 926. This response not only acknowledges the message but also adds a fun element to the conversation, reflecting the user's personality or preferences. By enabling the virtual pet to respond in such situations, the messaging experience becomes more dynamic and engaging, even when the user is not actively interacting with the app.

When the user is away from the messaging application, there are several ways the system can detect that the user cannot respond at that moment. The system can check the time since the last user action within the messaging application. If it exceeds a certain threshold indicating inactivity, the system can assume the user is away. In some cases, monitoring whether the messaging application is actively running or has been closed on the user's mobile device can also signal that the user is not available to respond.

Detection of overall device inactivity, such as no screen touches or movements for a period, may indicate that the user is not actively engaging with their phone. The system may check if the user has enabled a “Do Not Disturb” mode or a similar setting that suggests they are unavailable to receive messages.

In the context of the messaging application, the system can integrate pet responses into the pet owner's interactions to add a unique and personalized touch to conversations. Suppose the user likes another user's post within the messaging application. The system can automatically add a pet response to this interaction. For instance, the pet could say something like, “Woof! I love that too!” or “Meow, you've got great taste!” This response not only acknowledges the user's action but also reflects the pet's personality and adds an element of fun to the interaction.

If the user responds positively to Leslie's pizza request with “How about Thursday 9 PM?” indicating agreement or acceptance, the system can trigger a pet response as well. The pet could add a playful comment like, “Perfect, that is after my evening walk!” This response aligns with the context of the conversation and adds a humorous touch. By incorporating pet responses into the pet owner's interactions, the system creates a more dynamic and interactive experience, making the conversations feel lively and personalized. It also enhances the bond between the user and their virtual pet, adding to the overall enjoyment of using the messaging application.

In some cases, the system can dynamically adjust the pet's characteristics, accessories, or animated actions based on various user attributes and behaviors. The system can access current use of computing devices owned by the user and trigger a change to the pet. For example, if the system detects that the user is listening to music, the system can adjust the pet's appearance by adding headphones to its avatar. This customization aligns with the user's current activity and enhances the visual representation of the pet's interaction with the user.

When the system detects that the user is in a moving vehicle based on GPS velocity data, the system can animate the pet by adding a window with the pet sticking its head out. If the user is walking, as indicated by data from a health application, the system can animate the pet by having it circle around a walking avatar. When the user's GPS location indicates they are at a coffee shop, the system can animate the pet by showing it drinking coffee.

By dynamically adjusting the pet's characteristics and actions based on user attributes, data, behaviors, and activity on an application or computing device, the system enhances personalization and engagement within the messaging app. Users can feel a stronger connection to their virtual pet as it reflects their current activities and environments in a playful and interactive way.

In some cases, the features related to the virtual pets and/or the corresponding triggers described herein are applied to the XR space. Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply. For example, the messaging application can be between two AR users. The virtual pet can be a 3D virtual pet, and the actions of the virtual pet can be overlaid on top of real world objects.

Triggers to cause changes in virtual pets or actions of virtual pets can be in response to data (such as sensor or device configuration data) collected from XR systems. Sensor data includes visual data, such as real-time images, videos, or camera feeds of the user's environment; depth sensor data that provide information about the distance of objects in the environment from a device; motion sensors (such as from a gyroscope, or accelerometer) that detect the orientation and movement of the device; GPS data that provide location data; magnetometer data used to detect the direction in which the device is pointing by detecting the Earth's magnetic field; and/or the like.

Sensor data includes light sensor data that measure the ambient light in the environment; proximity sensor data that detect the presence of nearby objects without any physical contact; audio sensors that capture sound data; touch sensor data that enable user interaction with the digital content, such as selecting options or moving objects; thermal sensor data that measure temperature; ultrasonic sensor data that measure the distance to an object by using sound waves; and/or the like.

Device configuration data includes device specification data with hardware and software specifications of the device such as processor type, memory capacity, battery status, an operating system version, and a software version; sensor configuration data that includes the calibration and sensitivity settings of the device's sensors; user preferences data that are adjustable by the user, such as language, brightness, volume, privacy settings, and the arrangement or selection of applications; and/or the like.

Device configuration data includes network configuration data related to Wi-Fi, Bluetooth, cellular data connection, proxy settings, virtual private network (VPN) configurations, and other network-related preferences; display configuration data including resolution, aspect ratio, brightness, contrast, color settings of the device's display, and the calibration of the visual overlay; interaction settings for gesture recognition, voice commands, haptic feedback, and other interaction modalities; location settings including permissions for location data use; and/or the like.

Systems and methods described herein include training a machine learning network, such as training to determine a context in messages between users or generate images or videos of virtual pets. The machine learning network can be trained to identify a topic of discussion within user interaction in a chat window, in messages sent in posts between users, in interactions in a third party application such as games, and/or other interactions between users. The machine learning algorithm can be trained using historical information that include historical interaction data among users and resulting context or topics for the interactions.

Training of models, such as AI models, is necessarily rooted in computer technology, and improves modeling technology by using training data to train such models and thereafter applying the models to new inputs to make inferences on the new inputs. Here, the new inputs can be interaction data of a current user with a friend or other user, such as messages that are currently being sent between two users. The trained machine learning model can determine a topic of discussion within the chat window.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new interaction data) and make predictions that the model was trained for based on the weights or scores that were adjusted during training. Such training of the machine learning models described herein reduces false positives and increases the performance of identifying contextual information within interaction data between users.

### Adding Virtual Pet to Profile

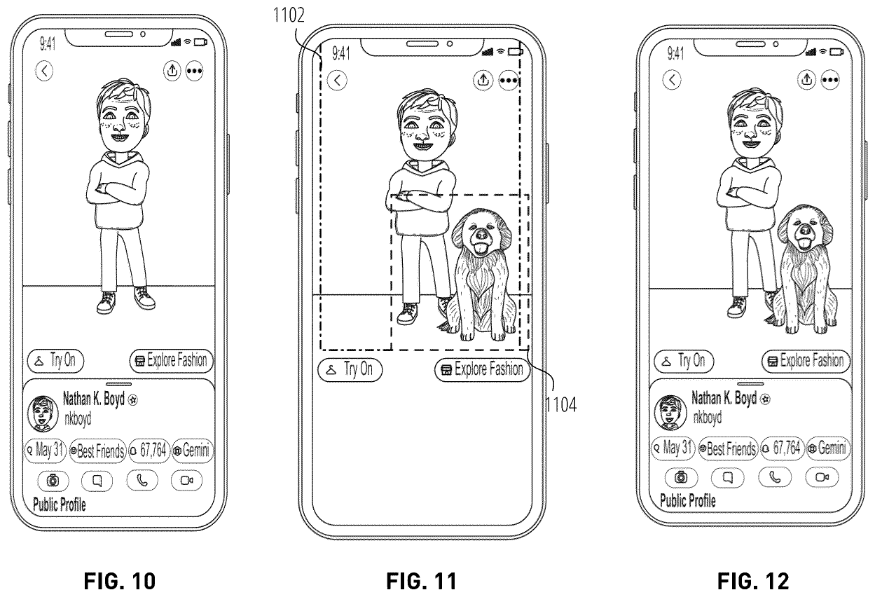

FIG. 10 illustrates a user's 3D avatar, according to some examples. A 3D avatar of the user on a profile screen can be visually represented in various ways to showcase the user's virtual identity. In some cases, the 3D avatar is designed to resemble the user based on selected preferences or customizable features. This includes options for hairstyle, facial features, clothing, accessories, and other personalized details. In other cases, the 3D avatar is created based on a user selection of design (e.g., body shape, hair color, cloths).

FIG. 11 illustrates guidelines to add a virtual pet adjacent to the user's avatar, according to some examples. On a profile page where a user has selected and enabled a virtual pet, the layout can be designed to visually separate the 3D avatar of the user from the virtual pet while maintaining a cohesive and engaging display.

Initially, the 3D avatar of the user is displayed prominently in the center of the profile page, as shown in FIG. 10. This avatar represents the user's virtual identity and serves as the focal point of the profile.

Upon enabling the virtual pet feature, the layout dynamically adjusts to create space for both the user's avatar and the virtual pet. The 3D avatar of the user is slightly moved to the side, such as to the left 1102, maintaining its visibility but creating room for the virtual pet's presence. The virtual pet is then displayed on the other side, slightly to the right 1104 of the user's 3D avatar. This positioning can be designed to appear as if the virtual pet is interacting with or accompanying the user's avatar.

To visually separate the user's avatar and the virtual pet, subtle design elements like space, alignment, or a subtle border can be used. This ensures that each element maintains its distinct identity within the profile layout. Both the user's avatar and the virtual pet can include interactive elements. For example, users may be able to click on their avatar to view or edit their profile, while interacting with the virtual pet may trigger animations or responses.

Relevant information about the virtual pet, such as its name, species, level, or mood, can be displayed alongside or below the pet's avatar. This provides context and enhances the user's connection with their virtual companion. By implementing this layout design, users can enjoy a visually appealing and organized profile page that showcases both their personal avatar and their chosen virtual pet in a harmonious and engaging manner.

FIG. 12 illustrates a final view of the user's avatar with the virtual pet, according to some examples. The final profile page can effectively display both the 3D avatar of the user and the virtual pet in a visually appealing and interactive manner. The virtual pet is positioned adjacent to the user's avatar, creating a sense of companionship and interaction. By implementing these design principles and interactive features, the final profile page effectively showcases both the user's 3D avatar and their virtual pet, creating a personalized and immersive experience for the user within the messaging app.

### Data Communications Architecture

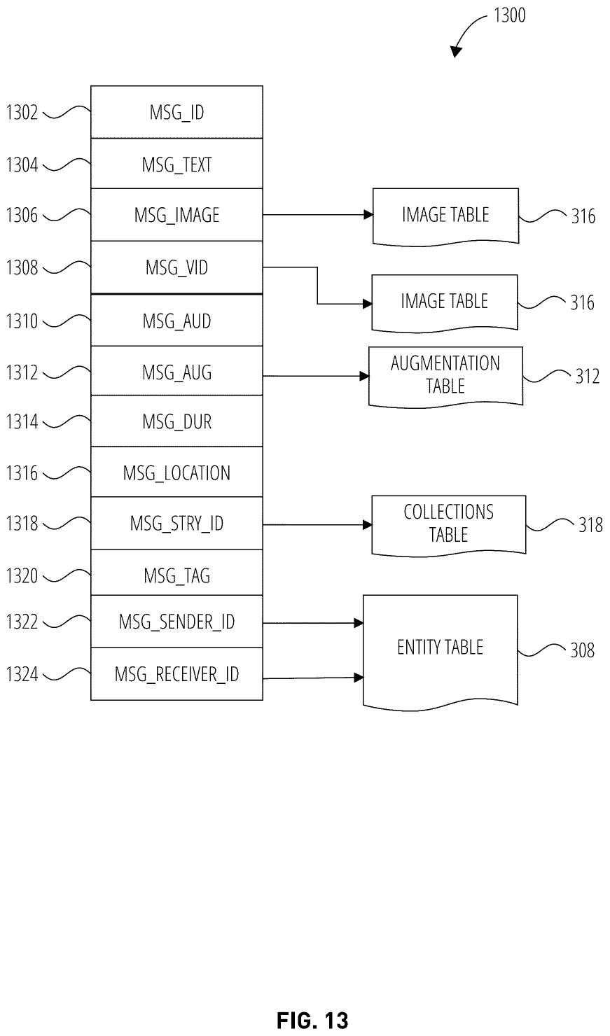

FIG. 13 is a schematic diagram illustrating a structure of a message 1300, according to some examples, generated by an interaction client 104 for communication to a further interaction client 104 via the interaction servers 124. The content of a particular message 1300 is used to populate the message table 306 stored within the database 304, accessible by the interaction servers 124. Similarly, the content of a message 1300 is stored in memory as “in-transit” or “in-flight” data of the user system 102 or the interaction servers 124. A message 1300 is shown to include the following example components:
Message identifier 1302: a unique identifier that identifies the message 1300.
Message text payload 1304: text, to be generated by a user via a user interface of the user system 102, and that is included in the message 1300.
Message image payload 1306: image data, captured by a camera component of a user system 102 or retrieved from a memory component of a user system 102, and that is included in the message 1300. Image data for a sent or received message 1300 may be stored in the image table 316.
Message video payload 1308: video data, captured by a camera component or retrieved from a memory component of the user system 102, and that is included in the message 1300. Video data for a sent or received message 1300 may be stored in the image table 316.
Message audio payload 1310: audio data, captured by a microphone or retrieved from a memory component of the user system 102, and that is included in the message 1300.
Message augmentation data 1312: augmentation data (e.g., filters, stickers, or other annotations or enhancements) that represents augmentations to be applied to message image payload 1306, message video payload 1308, or message audio payload 1310 of the message 1300. Augmentation data for a sent or received message 1300 may be stored in the augmentation table 312.
Message duration parameter 1314: parameter value indicating, in seconds, the amount of time for which content of the message (e.g., the message image payload 1306, message video payload 1308, message audio payload 1310) is to be presented or made accessible to a user via the interaction client 104.
Message geolocation parameter 1316: geolocation data (e.g., latitudinal and longitudinal coordinates) associated with the content payload of the message. Multiple message geolocation parameter 1316 values may be included in the payload, each of these parameter values being associated with respect to content items included in the content (e.g., a specific image within the message image payload 1306, or a specific video in the message video payload 1308).
Message story identifier 1318: identifier values identifying one or more content collections (e.g., “stories” identified in the collections table 318) with which a particular content item in the message image payload 1306 of the message 1300 is associated. For example, multiple images within the message image payload 1306 may each be associated with multiple content collections using identifier values.
Message tag 1320: each message 1300 may be tagged with multiple tags, each of which is indicative of the subject matter of content included in the message payload. For example, where a particular image included in the message image payload 1306 depicts an animal (e.g., a lion), a tag value may be included within the message tag 1320 that is indicative of the relevant animal. Tag values may be generated manually, based on user input, or may be automatically generated using, for example, image recognition.
Message sender identifier 1322: an identifier (e.g., a messaging system identifier, email address, or device identifier) indicative of a user of the user system 102 on which the message 1300 was generated and from which the message 1300 was sent.
Message receiver identifier 1324: an identifier (e.g., a messaging system identifier, email address, or device identifier) indicative of a user of the user system 102 to which the message 1300 is addressed.

The contents (e.g., values) of the various components of message 1300 may be pointers to locations in tables within which content data values are stored. For example, an image value in the message image payload 1306 may be a pointer to (or address of) a location within an image table 316. Similarly, values within the message video payload 1308 may point to data stored within an image or video table 316, values stored within the message augmentation data 1312 may point to data stored in an augmentation table 312, values stored within the message story identifier 1318 may point to data stored in a collections table 318, and values stored within the message sender identifier 1322 and the message receiver identifier 1324 may point to user records stored within an entity table 308.

System with Head-Wearable Apparatus

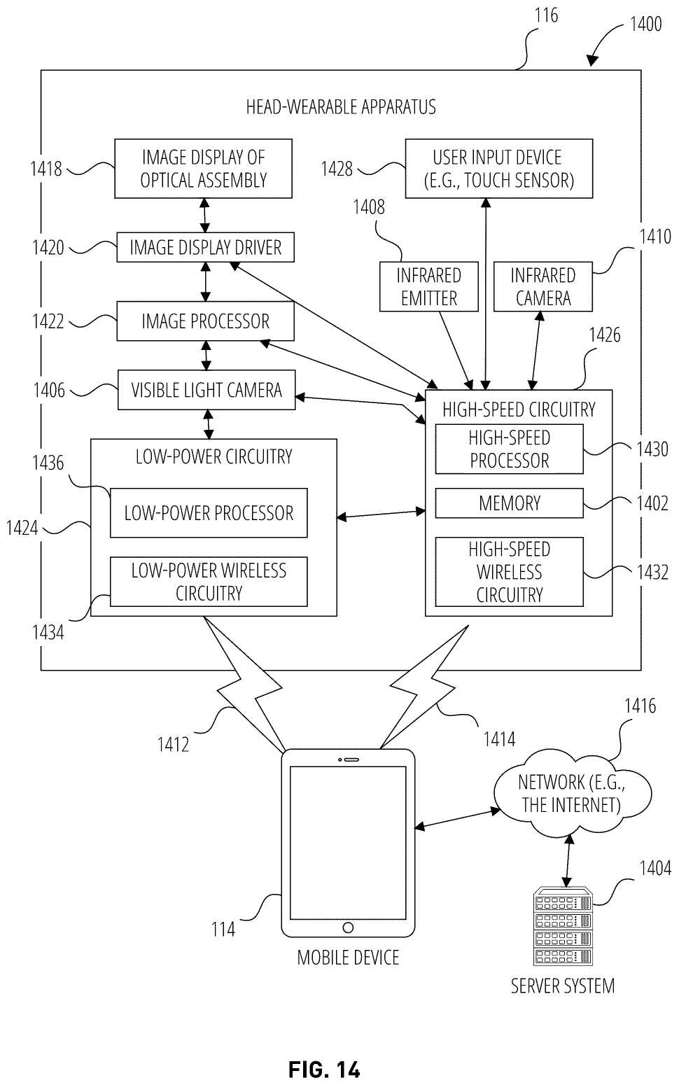

FIG. 14 illustrates a system 1400 including a head-wearable apparatus 116 with a selector input device, according to some examples. FIG. 14 is a high-level functional block diagram of an example head-wearable apparatus 116 communicatively coupled to a mobile device 114 and various server systems 1404 (e.g., the interaction server system 110) via various networks 108. The networks 108 may include any combination of wired and wireless connections.

The head-wearable apparatus 116 includes one or more cameras, each of which may be, for example, a visible light camera 1406, an infrared emitter 1408, and an infrared camera 1410.

An interaction client, such as a mobile device 114 connects with head-wearable apparatus 116 using both a low-power wireless connection 1412 and a high-speed wireless connection 1414. The mobile device 114 is also connected to the server system 1404 and the network 1416.

The head-wearable apparatus 116 further includes two image displays of the image display of optical assembly 1418. The two image displays of optical assembly 1418 include one associated with the left lateral side and one associated with the right lateral side of the head-wearable apparatus 116. The head-wearable apparatus 116 also includes an image display driver 1420, an image processor 1422, low-power circuitry 1424, and high-speed circuitry 1426. The image display of optical assembly 1418 is for presenting images and videos, including an image that can include a graphical user interface to a user of the head-wearable apparatus 116.

The image display driver 1420 commands and controls the image display of optical assembly 1418. The image display driver 1420 may deliver image data directly to the image display of optical assembly 1418 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1428 (e.g., touch sensor or push button), including an input surface on the head-wearable apparatus 116. The user input device 1428 (e.g., touch sensor or push button) is to receive from the user an input selection to manipulate the graphical user interface of the presented image.

The components shown in FIG. 14 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1406 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1402, which stores instructions to perform a subset or all of the functions described herein. The memory 1402 can also include storage device.

As shown in FIG. 14, the high-speed circuitry 1426 includes a high-speed processor 1430, a memory 1402, and high-speed wireless circuitry 1432. In some examples, the image display driver 1420 is coupled to the high-speed circuitry 1426 and operated by the high-speed processor 1430 in order to drive the left and right image displays of the image display of optical assembly 1418. The high-speed processor 1430 may be any processor capable of managing high-speed communications and operation of any general computing system needed for the head-wearable apparatus 116. The high-speed processor 1430 includes processing resources needed for managing high-speed data transfers on a high-speed wireless connection 1414 to a wireless local area network (WLAN) using the high-speed wireless circuitry 1432. In certain examples, the high-speed processor 1430 executes an operating system such as a LINUX operating system or other such operating system of the head-wearable apparatus 116, and the operating system is stored in the memory 1402 for execution. In addition to any other responsibilities, the high-speed processor 1430 executing a software architecture for the head-wearable apparatus 116 is used to manage data transfers with high-speed wireless circuitry 1432. In certain examples, the high-speed wireless circuitry 1432 is configured to implement Institute of Electrical and Electronic Engineers (IEEE) 802.11 communication standards, also referred to herein as WI-FI®. In some examples, other high-speed communications standards may be implemented by the high-speed wireless circuitry 1432.

The low-power wireless circuitry 1434 and the high-speed wireless circuitry 1432 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 1412 and the high-speed wireless connection 1414, may be implemented using details of the architecture of the head-wearable apparatus 116, as can other elements of the network 1416.

The memory 1402 includes any storage device capable of storing various data and applications, including, among other things, camera data generated by the left and right visible light cameras 1406, the infrared camera 1410, and the image processor 1422, as well as images generated for display by the image display driver 1420 on the image displays of the image display of optical assembly 1418. While the memory 1402 is shown as integrated with high-speed circuitry 1426, in some examples, the memory 1402 may be an independent standalone element of the head-wearable apparatus 116. In certain such examples, electrical routing lines may provide a connection through a chip that includes the high-speed processor 1430 from the image processor 1422 or the low-power processor 1436 to the memory 1402. In some examples, the high-speed processor 1430 may manage addressing of the memory 1402 such that the low-power processor 1436 will boot the high-speed processor 1430 any time that a read or write operation involving memory 1402 is needed.

As shown in FIG. 14, the low-power processor 1436 or high-speed processor 1430 of the head-wearable apparatus 116 can be coupled to the camera (visible light camera 1406, infrared emitter 1408, or infrared camera 1410), the image display driver 1420, the user input device 1428 (e.g., touch sensor or push button), and the memory 1402.

The head-wearable apparatus 116 is connected to a host computer. For example, the head-wearable apparatus 116 is paired with the mobile device 114 via the high-speed wireless connection 1414 or connected to the server system 1404 via the network 1416. The server system 1404 may be one or more computing devices as part of a service or network computing system, for example, that includes a processor, a memory, and network communication interface to communicate over the network 1416 with the mobile device 114 and the head-wearable apparatus 116.

The mobile device 114 includes a processor and a network communication interface coupled to the processor. The network communication interface allows for communication over the network 1416, low-power wireless connection 1412, or high-speed wireless connection 1414. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1420. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1404, such as the user input device 1428, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1412 and high-speed wireless connection 1414 from the mobile device 114 via the low-power wireless circuitry 1434 or high-speed wireless circuitry 1432.

### Machine Architecture

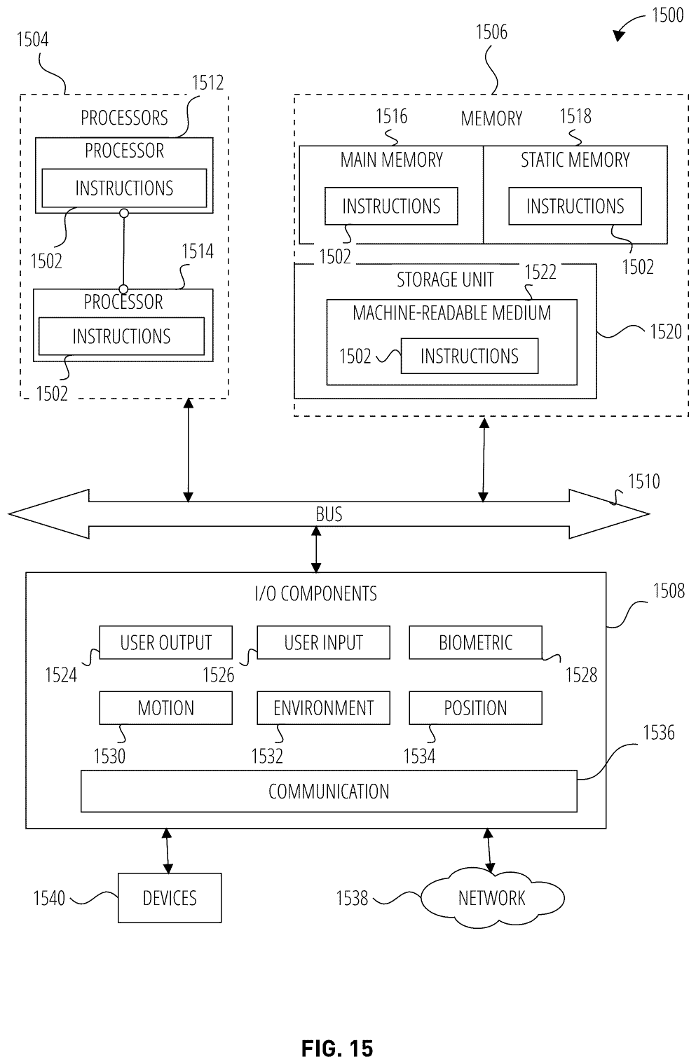

FIG. 15 is a diagrammatic representation of the machine 1500 within which instructions 1502 (e.g., software, a program, an application, an applet, an app, or other executable code) for causing the machine 1500 to perform any one or more of the methodologies discussed herein may be executed. For example, the instructions 1502 may cause the machine 1500 to execute any one or more of the methods described herein. The instructions 1502 transform the general, non-programmed machine 1500 into a particular machine 1500 programmed to carry out the described and illustrated functions in the manner described. The machine 1500 may operate as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1502, sequentially or otherwise, that specify actions to be taken by the machine 1500. Further, while a single machine 1500 is illustrated, the term “machine” shall also be taken to include a collection of machines that individually or jointly execute the instructions 1502 to perform any one or more of the methodologies discussed herein. The machine 1500, for example, may comprise the user system 102 or any one of multiple server devices forming part of the interaction server system 110. In some examples, the machine 1500 may also comprise both client and server systems, with certain operations of a particular method or algorithm being performed on the server-side and with certain operations of the particular method or algorithm being performed on the client-side.

The machine 1500 may include processors 1504, memory 1506, and input/output I/O components 1508, which may be configured to communicate with each other via a bus 1510. In an example, the processors 1504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1512 and a processor 1514 that execute the instructions 1502. The term “processor” is intended to include multi-core processors that may comprise two or more independent processors (sometimes referred to as “cores”) that may execute instructions contemporaneously. Although FIG. 15 shows multiple processors 1504, the machine 1500 may include a single processor with a single-core, a single processor with multiple cores (e.g., a multi-core processor), multiple processors with a single core, multiple processors with multiples cores, or any combination thereof.

The memory 1506 includes a main memory 1516, a static memory 1518, and a storage unit 1520, both accessible to the processors 1504 via the bus 1510. The main memory 1506, the static memory 1518, and storage unit 1520 store the instructions 1502 embodying any one or more of the methodologies or functions described herein. The instructions 1502 may also reside, completely or partially, within the main memory 1516, within the static memory 1518, within machine-readable medium 1522 within the storage unit 1520, within at least one of the processors 1504 (e.g., within the processor's cache memory), or any suitable combination thereof, during execution thereof by the machine 1500.

The I/O components 1508 may include a wide variety of components to receive input, provide output, produce output, transmit information, exchange information, capture measurements, and so on. The specific I/O components 1508 that are included in a particular machine will depend on the type of machine. For example, portable machines such as mobile phones may include a touch input device or other such input mechanisms, while a headless server machine will likely not include such a touch input device. It will be appreciated that the I/O components 1508 may include many other components that are not shown in FIG. 15. In various examples, the I/O components 1508 may include user output components 1524 and user input components 1526. The user output components 1524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1508 may include biometric components 1528, motion components 1530, environmental components 1532, or position components 1534, among a wide array of other components. For example, the biometric components 1528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1530 include acceleration sensor components (e.g., accelerometer), gravitation sensor components, rotation sensor components (e.g., gyroscope).

The environmental components 1532 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1534 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1508 further include communication components 1536 operable to couple the machine 1500 to a network 1538 or devices 1540 via respective coupling or connections. For example, the communication components 1536 may include a network interface component or another suitable device to interface with the network 1538. In further examples, the communication components 1536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1540 may be another machine or any of a wide variety of peripheral devices (e.g., a peripheral device coupled via a USB).

Moreover, the communication components 1536 may detect identifiers or include components operable to detect identifiers. For example, the communication components 1536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1536, such as location via IP geolocation, location via Wi-Fi® signal triangulation, location via detecting an NFC beacon signal that may indicate a particular location, and so forth.

The various memories (e.g., main memory 1516, static memory 1518, and memory of the processors 1504) and storage unit 1520 may store one or more sets of instructions and data structures (e.g., software) embodying or used by any one or more of the methodologies or functions described herein. These instructions (e.g., the instructions 1502), when executed by processors 1504, cause various operations to implement the disclosed examples.

The instructions 1502 may be transmitted or received over the network 1538, using a transmission medium, via a network interface device (e.g., a network interface component included in the communication components 1536) and using any one of several well-known transfer protocols (e.g., hypertext transfer protocol (HTTP)). Similarly, the instructions 1502 may be transmitted or received using a transmission medium via a coupling (e.g., a peer-to-peer coupling) to the devices 1540.

### Software Architecture

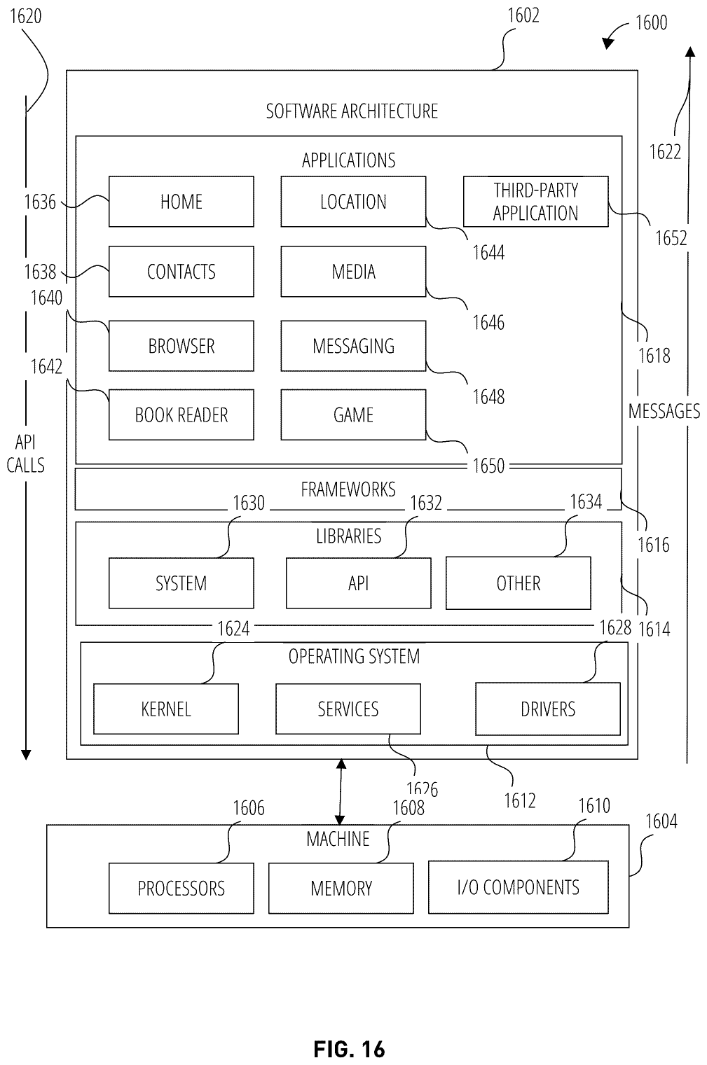

FIG. 16 is a block diagram 1600 illustrating a software architecture 1602, which can be installed on any one or more of the devices described herein. The software architecture 1602 is supported by hardware such as a machine 1604 that includes processors 1606, memory 1608, and I/O components 1610. In this example, the software architecture 1602 can be conceptualized as a stack of layers, where each layer provides a particular functionality. The software architecture 1602 includes layers such as an operating system 1612, libraries 1614, frameworks 1616, and applications 1618. Operationally, the applications 1618 invoke API calls 1620 through the software stack and receive messages 1622 in response to the API calls 1620.

The operating system 1612 manages hardware resources and provides common services. The operating system 1612 includes, for example, a kernel 1624, services 1626, and drivers 1628. The kernel 1624 acts as an abstraction layer between the hardware and the other software layers. For example, the kernel 1624 provides memory management, processor management (e.g., scheduling), component management, networking, and security settings, among other functionalities. The services 1626 can provide other common services for the other software layers. The drivers 1628 are responsible for controlling or interfacing with the underlying hardware. For instance, the drivers 1628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1614 provide a common low-level infrastructure used by the applications 1618. The libraries 1614 can include system libraries 1630 (e.g., C standard library) that provide functions such as memory allocation functions, string manipulation functions, mathematic functions, and the like. In addition, the libraries 1614 can include API libraries 1632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1614 can also include a wide variety of other libraries 1634 to provide many other APIs to the applications 1618.

The frameworks 1616 provide a common high-level infrastructure that is used by the applications 1618. For example, the frameworks 1616 provide various graphical user interface (GUI) functions, high-level resource management, and high-level location services. The frameworks 1616 can provide a broad spectrum of other APIs that can be used by the applications 1618, some of which may be specific to a particular operating system or platform.

In an example, the applications 1618 may include a home application 1636, a contacts application 1638, a browser application 1640, a book reader application 1642, a location application 1644, a media application 1646, a messaging application 1648, a game application 1650, and a broad assortment of other applications such as a third-party application 1652. The applications 1618 are programs that execute functions defined in the programs. Various programming languages can be employed to create one or more of the applications 1618, structured in a variety of manners, such as object-oriented programming languages (e.g., Objective-C, Java, or C++) or procedural programming languages (e.g., C or assembly language). In a specific example, the third-party application 1652 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1652 can invoke the API calls 1620 provided by the operating system 1612 to facilitate functionalities described herein.

### Machine-Learning Pipeline

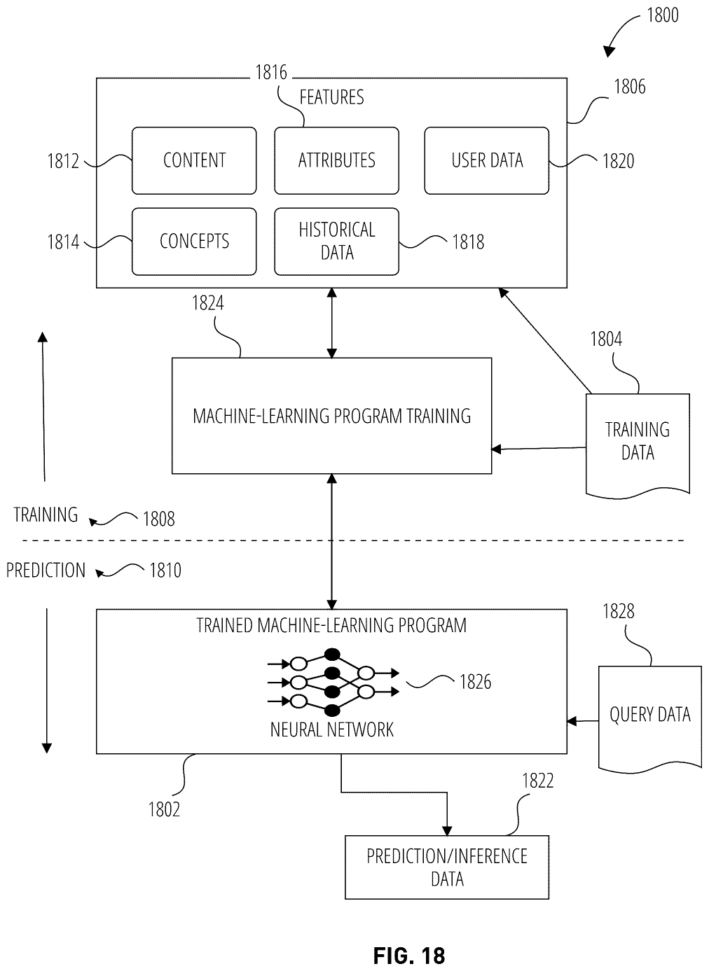

FIG. 18 is a flowchart depicting a machine-learning pipeline 1800, according to some examples. The machine-learning pipelines 1800 may be used to generate a trained model, for example the trained machine-learning program 1802 of FIG. 18, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

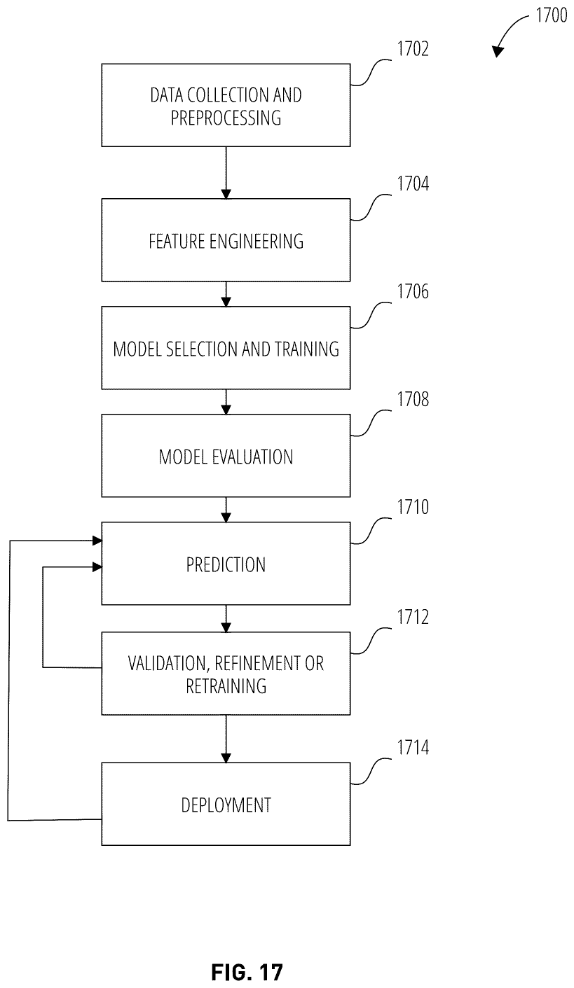

Generating a trained machine-learning program 1802 may include multiple types of phases that form part of the machine-learning pipeline 1800, including for example the following phases 1700 illustrated in FIG. 17:
Data collection and preprocessing 1702: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1704: This may include selecting and transforming the training data 1804 to create features that are useful for predicting the target variable. Feature engineering may include (1) receiving features 1806 (e.g., as structured or labeled data in supervised learning) and/or (2) identifying features 1806 (e.g., unstructured or unlabeled data for unsupervised learning) in training data 1804.
Model selection and training 1706: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1708: This may include evaluating the performance of a trained model (e.g., the trained machine-learning program 1802) on a separate testing dataset. This can help determine if the model is overfitting or underfitting and if it is suitable for deployment.
Prediction 1710: This involves using a trained model (e.g., trained machine-learning program 1802) to generate predictions on new, unseen data.
Validation, refinement or retraining 1712: This may include updating a model based on feedback generated from the prediction phase, such as new data or user feedback.
Deployment 1714: This may include integrating the trained model (e.g., the trained machine-learning program 1802) into a larger system or application, such as a web service, mobile app, or IoT device. This can involve setting up APIs, building a user interface, and ensuring that the model is scalable and can handle large volumes of data.

FIG. 18 illustrates two example phases, namely a training phase 1808 (part of the model selection and trainings 1706) and a prediction phase 1810 (part of prediction 1710). Prior to the training phase 1808, feature engineering 1704 is used to identify features 1806. This may include identifying informative, discriminating, and independent features for the effective operation of the trained machine-learning program 1802 in pattern recognition, classification, and regression. In some examples, the training data 1804 includes labeled data, which is known data for pre-identified features 1806 and one or more outcomes.

Each of the features 1806 may be a variable or attribute, such as individual measurable property of a process, article, system, or phenomenon represented by a data set (e.g., the training data 1804). Features 1806 may also be of different types, such as numeric features, strings, vectors, matrices, encodings, and graphs, and may include one or more of content 1812, concepts 1814, attributes 1816, historical data 1818 and/or user data 1820, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1808, the machine-learning pipeline 1800 uses the training data 1804 to find correlations among the features 1806 that affect a predicted outcome or prediction/inference data 1822.

With the training data 1804 and the identified features 1806, the trained machine-learning program 1802 is trained during the training phase 1808 during machine-learning program training 1824. The machine-learning program training 1824 appraises values of the features 1806 as they correlate to the training data 1804. The result of the training is the trained machine-learning program 1802 (e.g., a trained or learned model).

Further, the training phase 1808 may involve machine learning, in which the training data 1804 is structured (e.g., labeled during preprocessing operations), and the trained machine-learning program 1802 implements a relatively simple neural network 1826 capable of performing, for example, classification and clustering operations. In other examples, the training phase 1808 may involve deep learning, in which the training data 1804 is unstructured, and the trained machine-learning program 1802 implements a deep neural network 1826 that is able to perform both feature extraction and classification/clustering operations.

A neural network 1826 may, in some examples, be generated during the training phase 1808, and implemented within the trained machine-learning program 1802. The neural network 1826 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1826 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1826 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1808, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1826 is iteratively trained by adjusting model parameters to minimize a specific loss function or maximize a certain objective. The system can continue to train the neural network 1826 by adjusting parameters based on the output of the validation, refinement, or retraining block 1712, and rerun the prediction 1710 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1826 even after deployment 1714 of the neural network 1826. The neural network 1826 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1810, the trained machine-learning program 1802 uses the features 1806 for analyzing query data 1828 to generate inferences, outcomes, or predictions, as examples of a prediction/inference data 1822. For example, during prediction phase 1810, the trained machine-learning program 1802 is used to generate an output. Query data 1828 is provided as an input to the trained machine-learning program 1802, and the trained machine-learning program 1802 generates the prediction/inference data 1822 as output, responsive to receipt of the query data 1828. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1802 may be a generative AI model. Generative AI is a term that may refer to any type of AI that can create new content from training data 1804. For example, generative AI can produce text, images, video, audio, code or synthetic data that are similar to the original data but not identical. Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1822 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: determining participation in an interaction function by a first user of an interaction system with a second user of the interaction system; accessing profile data of the first user; determining, based on the profile data, whether the first user has a virtual pet for use in the interaction function; in response to determining that the first user has the virtual pet for use in the interaction function, initiating display of the virtual pet with an avatar of the first user in an uncollapsed state in the interaction function to a computing device of the second user; determining that the first user is typing a message in the interaction function; and in response to determining that the first user is typing the message in the interaction function, initiating display of the virtual pet with the avatar of the first user in a first state in the interaction function, the first state including a visual indicator indicating that the first user is typing the message.

In Example 2, the subject matter of Example 1 includes, wherein the operations further comprise: determining a threshold of time has elapsed; and in response to determining that the threshold of time has elapsed, initiating display of a second state in the interaction function, the first state being between the uncollapsed state and a collapsed state of the virtual pet with the avatar of the first user.

In Example 3, the subject matter of Examples 1-2 includes, wherein the visual indicator includes a visual cloud above a user avatar's head.

In Example 4, the subject matter of Examples 1-3 includes, wherein the interaction function includes a messaging application configured to enable the first user and the second user to send messages to each other, wherein the virtual pet is displayed between one or more messages between the first and second user and a keyboard for typing the messages.

In Example 5, the subject matter of Examples 1˜4 includes, wherein the operations further comprise: dynamically adjusting a pixel value for the first state based on a characteristic of a computing device of the first user.

In Example 6, the subject matter of Examples 1-5 includes, wherein the operations further comprise: inputting at least a portion of the profile data into a large language model to receive a pet preference for the first user, the large language model trained to receive profile data of users and output a preference of a pet characteristic for the first user; and generating the virtual pet of the first user based on the pet characteristic for the first user.

In Example 7, the subject matter of Example 6 includes, wherein generating the virtual pet comprises applying the pet characteristic to a generative artificial intelligence model as a prompt to receive an image of a pet, the generative artificial intelligence model trained to generate images based on corresponding inputted prompts.

In Example 8, the subject matter of Example 7 includes, wherein the generative artificial intelligence model includes a stable diffusion model that introduces noise iteratively to update pixel values in a generated image based on neighboring pixels to generate the virtual pet.

In Example 9, the subject matter of Examples 1-8 includes, wherein the operations further comprise: identifying a message exchanged by the first user and the second user; processing the message in a large language model to identify context of the message; and applying the identified context and the virtual pet to a generative artificial intelligence model to generate a modified virtual pet corresponding to the context of the message between the first user and the second user.

In Example 10, the subject matter of Examples 1-9 includes, wherein the operations further comprise: identifying a characteristic of the first user based on a first user's participation in a second interaction function; and generating the virtual pet using a generative artificial intelligence model by inputting the identified characteristic of the first user into the generative artificial intelligence model.

In Example 11, the subject matter of Examples 1-10 includes, identifying a characteristic of a real world pet owned by the first user based on a first user's participation in a second interaction function; and generating the virtual pet using a generative artificial intelligence model by inputting the identified characteristic of the real world pet owned by the first user into the generative artificial intelligence model.

In Example 12, the subject matter of Examples 1-11 includes, wherein the first state comprises a visual indicator applied to the avatar of the second user indicating that the second user is typing.

In Example 13, the subject matter of Example 12 includes, wherein the first state further comprises a modification of the virtual pet illustrating a response to the second user typing.

In Example 14, the subject matter of Examples 1-13 includes, wherein the operations further comprise: receiving a message from the second user; determining that the first user is not currently active on the interaction function; and initiating a message to be displayed to the interaction function, the message being displayed as sent by the virtual pet.

In Example 15, the subject matter of Example 14 includes, wherein determining that the first user is not currently active on the interaction function is based on a time since a last user action on the interaction function.

In Example 16, the subject matter of Examples 14-15 includes,) a “Do Not Disturb” mode on the user device of the first user.

In Example 17, the subject matter of Examples 1-16 includes, wherein the operations further comprise: identifying a characteristic of the first user based on data collected from a computing device of the first user; and initiating an animation of the virtual pet corresponding to the characteristic of the first user.

In Example 18, the subject matter of Example 17 includes, wherein the characteristic includes a GPS location of the first user, a velocity of the first user, or health data of the first user.

Example 19 is a method comprising: determining participation in an interaction function by a first user of an interaction system with a second user of the interaction system; accessing profile data of the first user; determining, based on the profile data, whether the first user has a virtual pet for use in the interaction function; in response to determining that the first user has the virtual pet for use in the interaction function, initiating display of the virtual pet with an avatar of the first user in an uncollapsed state in the interaction function to a computing device of the second user; determining that the first user is typing a message in the interaction function; and in response to determining that the first user is typing the message in the interaction function, initiating display of the virtual pet with the avatar of the first user in a first state in the interaction function, the first state including a visual indicator indicating that the first user is typing the message.

Example 20 is a non-transitory computer-readable storage medium storing instructions that, when executed by at least one processor, cause the at least one processor to perform operations comprising: determining participation in an interaction function by a first user of an interaction system with a second user of the interaction system; accessing profile data of the first user; determining, based on the profile data, whether the first user has a virtual pet for use in the interaction function; in response to determining that the first user has the virtual pet for use in the interaction function, initiating display of the virtual pet with an avatar of the first user in an uncollapsed state in the interaction function to a computing device of the second user; determining that the first user is typing a message in the interaction function; and in response to determining that the first user is typing the message in the interaction function, initiating display of the virtual pet with the avatar of the first user in a first state in the interaction function, the first state including a visual indicator indicating that the first user is typing the message.

Example 21 is at least one machine-readable medium including instructions that, when executed by processing circuitry, cause the processing circuitry to perform operations to implement of any of Examples 1-20.

Example 22 is an apparatus comprising means to implement any of Examples 1-20.

Example 23 is a system to implement any of Examples 1-20.

Example 24 is a method to implement any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
determining participation in an interaction function by a first user of an interaction system with a second user of the interaction system;
accessing profile data of the first user;
determining, based on the profile data, whether the first user has a virtual pet for use in the interaction function;
in response to determining that the first user has the virtual pet for use in the interaction function, initiating display of the virtual pet with an avatar of the first user in an uncollapsed state in the interaction function to a computing device of the second user;
determining that the first user is typing a message in the interaction function; and
in response to determining that the first user is typing the message in the interaction function, initiating display of the virtual pet with the avatar of the first user in a first state in the interaction function, the first state including a visual indicator indicating that the first user is typing the message.

2. The system of claim 1, wherein the operations further comprise:
determining a threshold of time has elapsed; and
in response to determining that the threshold of time has elapsed, initiating display of a second state in the interaction function, the first state being between the uncollapsed state and a collapsed state of the virtual pet with the avatar of the first user.

3. The system of claim 1, wherein the visual indicator includes a visual cloud above a user avatar's head.

4. The system of claim 1, wherein the interaction function includes a messaging application configured to enable the first user and the second user to send messages to each other, wherein the virtual pet is displayed between one or more messages between the first and second user and a keyboard for typing the messages.

5. The system of claim 1, wherein the operations further comprise: dynamically adjusting a pixel value for the first state based on a characteristic of a computing device of the first user.

6. The system of claim 1, wherein the operations further comprise:
inputting at least a portion of the profile data into a large language model to receive a pet preference for the first user, the large language model trained to receive profile data of users and output a preference of a pet characteristic for the first user; and
generating the virtual pet of the first user based on the pet characteristic for the first user.

7. The system of claim 6, wherein generating the virtual pet comprises applying the pet characteristic to a generative artificial intelligence model as a prompt to receive an image of a pet, the generative artificial intelligence model trained to generate images based on corresponding inputted prompts.

8. The system of claim 7, wherein the generative artificial intelligence model includes a stable diffusion model that introduces noise iteratively to update pixel values in a generated image based on neighboring pixels to generate the virtual pet.

9. The system of claim 1, wherein the operations further comprise:
identifying a message exchanged by the first user and the second user;
processing the message in a large language model to identify context of the message; and
applying the identified context and the virtual pet to a generative artificial intelligence model to generate a modified virtual pet corresponding to the context of the message between the first user and the second user.

10. The system of claim 1, wherein the operations further comprise:
identifying a characteristic of the first user based on a first user's participation in a second interaction function; and
generating the virtual pet using a generative artificial intelligence model by inputting the identified characteristic of the first user into the generative artificial intelligence model.

11. The system of claim 1, identifying a characteristic of a real world pet owned by the first user based on a first user's participation in a second interaction function; and
generating the virtual pet using a generative artificial intelligence model by inputting the identified characteristic of the real world pet owned by the first user into the generative artificial intelligence model.

12. The system of claim 1, wherein the first state comprises a visual indicator applied to the avatar of the second user indicating that the second user is typing.

13. The system of claim 12, wherein the first state further comprises a modification of the virtual pet illustrating a response to the second user typing.

14. The system of claim 1, wherein the operations further comprise:
receiving a message from the second user;
determining that the first user is not currently active on the interaction function; and
initiating a message to be displayed to the interaction function, the message being displayed as sent by the virtual pet.

15. The system of claim 14, wherein determining that the first user is not currently active on the interaction function is based on a time since a last user action on the interaction function.

16. The system of claim 14, wherein determining that the first user is not currently active on the interaction function is based on (1) determining whether an application that is executing the interaction function has been closed on a user device of the first user, (2) touch screen or movements on the user device of the first user, or (3) a “Do Not Disturb” mode on the user device of the first user.

17. The system of claim 1, wherein the operations further comprise:
identifying a characteristic of the first user based on data collected from a computing device of the first user; and
initiating an animation of the virtual pet corresponding to the characteristic of the first user.

18. The system of claim 17, wherein the characteristic includes a GPS location of the first user, a velocity of the first user, or health data of the first user.

19. A method comprising:
determining participation in an interaction function by a first user of an interaction system with a second user of the interaction system;
accessing profile data of the first user;
determining, based on the profile data, whether the first user has a virtual pet for use in the interaction function;
in response to determining that the first user has the virtual pet for use in the interaction function, initiating display of the virtual pet with an avatar of the first user in an uncollapsed state in the interaction function to a computing device of the second user;
determining that the first user is typing a message in the interaction function; and
in response to determining that the first user is typing the message in the interaction function, initiating display of the virtual pet with the avatar of the first user in a first state in the interaction function, the first state including a visual indicator indicating that the first user is typing the message.

20. A non-transitory computer-readable storage medium storing instructions that, when executed by at least one processor, cause the at least one processor to perform operations comprising:
determining participation in an interaction function by a first user of an interaction system with a second user of the interaction system;
accessing profile data of the first user;
determining, based on the profile data, whether the first user has a virtual pet for use in the interaction function;
in response to determining that the first user has the virtual pet for use in the interaction function, initiating display of the virtual pet with an avatar of the first user in an uncollapsed state in the interaction function to a computing device of the second user;
determining that the first user is typing a message in the interaction function; and
in response to determining that the first user is typing the message in the interaction function, initiating display of the virtual pet with the avatar of the first user in a first state in the interaction function, the first state including a visual indicator indicating that the first user is typing the message.
